(19) United States
(12) Patent Application Publication
(10) Pub. No.: US 2014/0184532 A1
(43) Pub. Date: Jul. 3, 2014

(54) DISPLAY SYSTEM AND CONTROL METHOD THEREOF

(71) Applicant: AU Optronics Corp., Hsin-Chu (TW)

(72) Inventors: Yin-Ting Lee, Hsin-Chu (TW); Chien-Hung Chen, Hsin-Chu (TW); Chang-Ho Shen, Hsin-Chu (TW)

(73) Assignee: AU Optronics Corp., Hsin-Chu (TW)

(21) Appl. No.: 13/967,321

(22) Filed: Aug. 14, 2013

(30) Foreign Application Priority Data
Dec. 27, 2012 (TW) 101150462

(51) Int. Cl. G06F 3/0354; G06F 3/041

(52) U.S. Cl. CPC G06F 3/03545; G06F 3/0412
USPC 345/173; 345/179

(57) ABSTRACT

A display system includes a stylus pen and a touch screen module. The touch screen module includes a touch screen. A control method of the display system includes activating a command input mode of the display system by the stylus pen. An input command from the stylus pen to the touch screen is received by the touch screen after the command input mode is activated. Performer a corresponding operation corresponding to the input command on the touch screen according to which command among a plurality of predetermined commands of the display system to which the input command corresponds.

### BACKGROUND OF THE DISCLOSURE

1. Field of the Disclosure

The present disclosure is related to a display system control method, and more particularly, to a method of performing corresponding operations according to paths of a stylus pen moving on a touch screen.

2. Description of Related Art

As applications of touch screens become more and more popular, there is an increasing demand for touch screens in classrooms or conferences. Touch screens having larger sizes such as electronic whiteboards are preferably used in classrooms or conferences, however, lengths and widths of the said touch screens are usually too wide for users to reach. A typical design of placing operation interfaces of the said touch screens adjacent to frame borders of the said touch screens may solve the said problem, but it may require the users to move back and forth in front of the said touch screens from time to time in order to select operation commands from the operation interfaces, which is a waste of time and is inconvenient to the users.

### SUMMARY OF THE DISCLOSURE

An embodiment of the disclosure discloses a display system control method. The display system comprises a stylus pen and a touch screen module. The touch screen module comprises a touch screen. The method comprises activating a command input mode of the display system by the stylus pen. The touch screen receives an input command from the stylus pen to the touch screen after the command input mode is activated, and then performs a corresponding operation corresponding to the input command on the touch screen according to which command among a plurality of predetermined commands of the display system to which the input command corresponds.

Another embodiment of the disclosure discloses a touch screen module for receiving inputs from a stylus. The touch screen module comprises a touch screen and a controller. The touch screen is for receiving an input command from the stylus pen to the touch screen. The controller is coupled to the touch screen and comprises a receiver. The receiver is for receiving a wireless control signal transmitted from the stylus pen. The controller controls the touch screen module to activate a command input mode according to the wireless control signal, determines which command among a plurality of predetermined commands to which the input command corresponds after the command input mode has been activated, and controls the touch screen to perform a corresponding operation corresponding to the input command in response to the command among the plurality of predetermined commands of the display system that the input command corresponds to after the command among the plurality of predetermined commands of the display system that the input command corresponds to has been determined.

Another embodiment of the disclosure discloses a display system control method. The display system comprises a stylus pen and a touch screen module. The touch screen module comprises a touch screen. The method comprises receiving an input command from the stylus pen to the touch screen by the touch screen. Determining if the display system has been activated a command input mode of the display system by the stylus pen in order to decide whether or not the input command should be determined to be corresponding to a command among a plurality of predetermined commands of the display system. After the command input mode of the display system has been activated by the stylus pen, determining which command among the plurality of predetermined commands of the display system to which the input command corresponds and performing a corresponding operation corresponding to the input command on the touch screen after the command among the plurality of predetermined commands of the display system that the input command corresponds to has been determined.

Another embodiment of the disclosure discloses a display system. The display system comprises a stylus pen and a touch screen module. The touch screen module comprises a touch screen and a controller. The stylus pen is configured to activate a command input mode of the display system. The touch screen is configured to receive an input command from the stylus pen to the touch screen. The controller is coupled to the touch screen and is configured to control the touch screen to perform a corresponding operation corresponding to the input command according to which command among a plurality of predetermined commands of the display system that the input command corresponds to after the command input mode has been activated.

Another embodiment of the disclosure discloses a display system. The display system comprises a stylus pen and a touch screen module. The touch screen module comprises receiving an input command from the stylus pen to the touch screen by the touch screen; according to whether the display system has activated a command input mode of the display system by the stylus pen to decide whether or not to determine which command among a plurality of predetermined commands of the display system the input command corresponds to; and after the command input mode of the display system has been activated by the stylus pen, determining which command among the plurality of predetermined commands of the display system to which the input command corresponds and performing a corresponding operation corresponding to the input command on the touch screen after the command among the plurality of predetermined commands of the display system that the input command corresponds to has been determined.

Another embodiment of the disclosure discloses a display system. The display system comprising a stylus pen configured to activate a command input mode of the display system; and a touch screen module configured to receive inputs of the stylus pen. The touch screen module comprises a touch screen configured to receive an input command from the stylus pen to the touch screen; and a controller coupled to the touch screen and configured to according to which command among a plurality of predetermined commands of the display system the input command corresponds to, control the touch screen to perform a corresponding operation corresponding to the input command after the command input mode has been activated.

In accordance with one specific embodiment of said display system, the controller is further configured to according to whether the command input mode has been activated by the stylus pen to decide whether or not to determine which command among a plurality of predetermined commands of the display system the input command corresponds to.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a display system according to an embodiment of the disclosure.

FIG. 2 is a flowchart illustrating control method for the display system of FIG. 1 or the display system of FIG. 3 according to an embodiment of the disclosure.

FIG. 3 is a diagram illustrating a display system according to another embodiment of the disclosure.

FIGS. 4 to 13 are diagrams illustrating the plurality of predetermined commands of the display system of FIG. 1 or the display system of FIG. 3 according to an embodiment of the disclosure.

### DETAILED DESCRIPTION

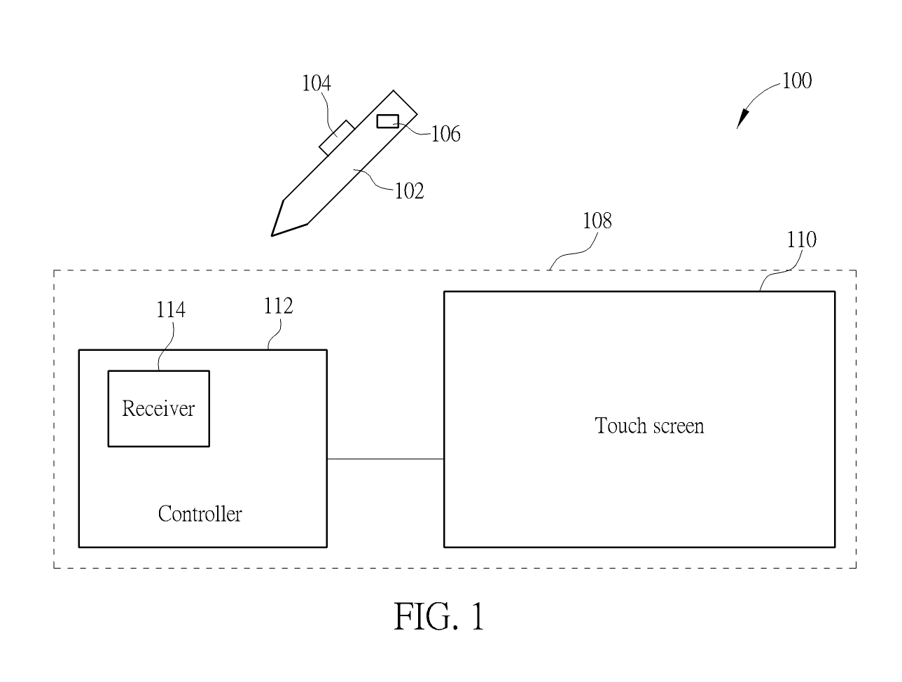

FIG. 1 is a diagram illustrating display system 100 according to an embodiment of the disclosure. The display system 100 may include a stylus pen 102 and a touch screen module 108. The stylus pen may include a switch 104 and a transmitter 106. The touch screen module 108 may include a touch screen 110 and a controller 112. The controller 112 is coupled to the touch screen 110 and may include a receiver 114.

The switch 104 may be configured to generate a wireless control signal and the wireless control signal may be transmitted to the touch screen module 108 by the transmitter 106. The receiver 114 is configured to receive the wireless control signal transmitted from the transmitter 106. The display system 100 may activate a command input mode in response to the wireless control signal after the wireless control signal has been received by the receiver 114, namely, the stylus pen 102 may be configured to active the command input mode of the display system 100. The touch screen 110 may be configured to receive an input command from the stylus pen 102 to the touch screen 110. The controller 112 is configured to determine which command among a plurality of predetermined commands of the display system 100 that the input command corresponds to after the command input mode of the display system 100 has been activated and is configured to control the touch screen 110 to perform a corresponding operation corresponding to the input command in response to the command among the plurality of predetermined commands of the display system 100 that the input command corresponds to after the command among the plurality of predetermined commands of the display system 100 that the input command corresponds to has been determined.

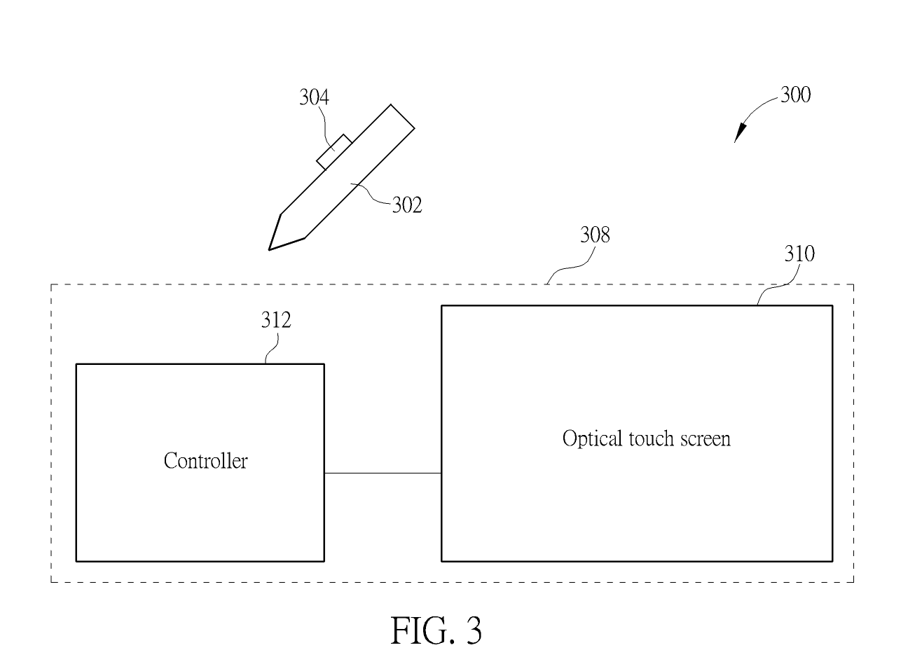

FIG. 3 is a diagram illustrating display system 300 according to another embodiment of the disclosure. The display system 300 may include an optical stylus pen 302 and a touch screen module 308. The optical stylus pen 302 may include a switch 304. The touch screen module 308 may include an optical touch screen 310 and a controller 312. The controller 312 is coupled to the optical touch screen 310. The switch 304 may be configured to control brightness and/or color of light emitted from the optical stylus pen 302. The display system 300 may activate the command input mode according to the brightness and/or color of light emitted from the optical stylus pen 302 to the optical touch screen 310.

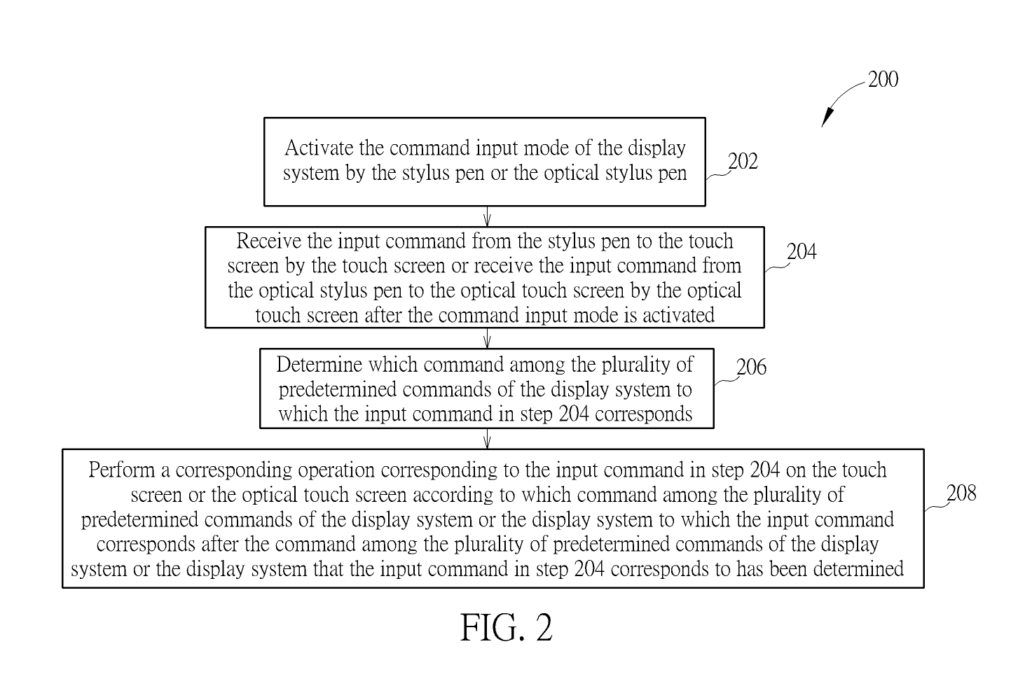

FIG. 2 is a flowchart illustrating control method 200 for the display system 100 of FIG. 1 or the display system 300 of FIG. 3 according to an embodiment of the disclosure. The method 200 may include the following steps.

Step 202: Activating the command input mode of the display system 100 or the display system 300 by the stylus pen 102 or the optical stylus pen 302.

Step 204: Receiving the input command from the stylus pen 102 to the touch screen 110 by the touch screen 110 or receive the input command from the optical stylus pen 302 to the optical touch screen 310 by the optical touch screen 310 after the command input mode is activated.

Step 206: Determining which command among the plurality of predetermined commands of the display system 100 or the display system 300 to which the input command in step 204 corresponds.

Step 208: Performing a corresponding operation corresponding to the input command in step 204 on the touch screen 110 or the optical touch screen 310 according to which command among the plurality of predetermined commands of the display system 100 or the display system 300 to which the input command corresponds after the command among the plurality of predetermined commands of the display system 100 or the display system 300 that the input command in step 204 corresponds to has been determined.

Take the display system 100 of FIG. 1 as an example. In step 202, a user may press the switch 104 of the stylus pen 102 to generate the wireless control signal. The wireless control signal may be transmitted to the touch screen module 108 by the transmitter 106. After the receiver 114 of the controller 112 of the touch screen module 108 has received the wireless control signal transmitted from the transmitter 106, the display system 100 activates the command input mode. In step 204, after the command input mode has been activated, the user may use the stylus pen 102 to input the input command on the touch screen 110. In step 206, the controller 112 may determine which command among the plurality of predetermined commands of the display system 100 that the input command in step 204 corresponds to and generate a corresponding result. The said predetermined commands will be detailed later. Next, in step 208, the controller 112 may control the touch screen 110 to perform the corresponding operation corresponding to the input command in step 204 according the corresponding result generated in step 206. If the user did not press the switch 104 of the stylus pen 102 for activating the command input mode of the display system 100, the stylus pen 102 may be used for writing or drawing on the touch screen 110 as it is commonly used for. In other words, the touch screen 110 may not perform the corresponding operation corresponding to the input command in step 204 even if the input command is corresponding to the command (such as a specific path) among the plurality of predetermined commands of the display system 100 before the user presses the switch 104 of the stylus pen 102 for activating the command input mode of the display system 100, which is referred as a common mode of the display system 100.

Take the display system 300 of FIG. 3 as another example. In step 202, the user may press the switch 304 of the optical stylus pen 302 to control brightness and/or color of light emitted from the optical stylus pen 302. After the optical touch screen 310 has received the brightness and/or color of light having increased intensity emitted from the optical stylus pen 302, the display system 300 activates the command input mode according to the brightness and/or color of light emitted from the optical stylus pen 302. In step 204, after the command input mode has been activated, the user may use the optical stylus pen 302 to input the input command on the optical touch screen 310. In step 206, the controller 312 may determine which command among the plurality of predetermined commands of the display system 300 that the input command in step 204 corresponds to and generate the corresponding result. Similarly, the said predetermined commands will be detailed later. Next, in step 208, the controller 312 may control the optical touch screen 310 to perform the corresponding operation corresponding to the input command in step 204 according to the corresponding result generated in step 206. If the user did not press the switch 304 of the optical stylus pen 302 for activating the command input mode of the display system 300, the optical stylus pen 302 may be used for writing or drawing on the optical touch screen 310 as it is commonly used for. In other words, the optical touch screen 310 may not perform the corresponding operation corresponding to the input command in step 204 even if the input command is corresponding to the command (such as a specific path) among the plurality of predetermined commands of the display system 300 before the user presses the switch 304 of the optical stylus pen 302 for activating the command input mode of the display system 300, which is referred as a common mode of the display system 300.

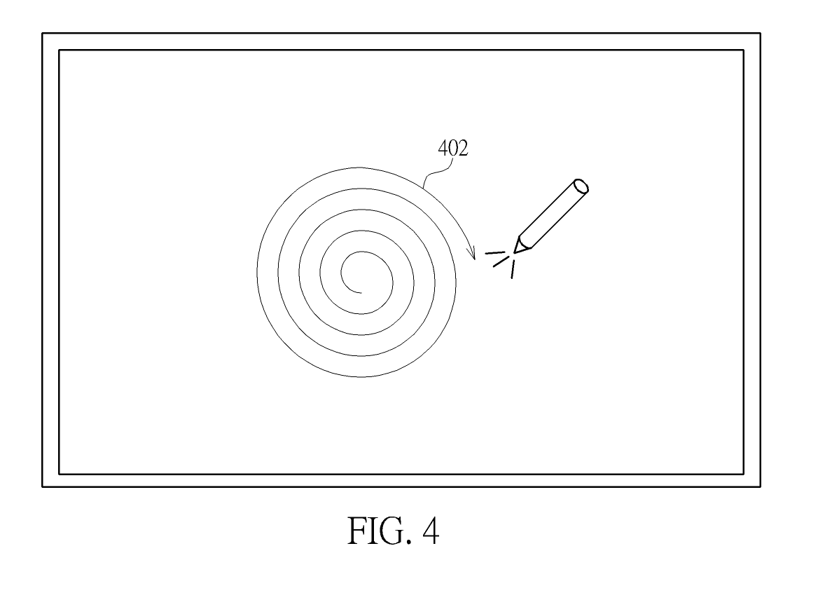

FIGS. 4 to 13 are diagrams illustrating the plurality of predetermined commands of the display system 100 of FIG. 1 or the display system 300 of FIG. 3 according to an embodiment of the disclosure. The display system 100 and the display system 300 may adopt the same predetermined commands. If the user uses the stylus pen 102 on the touch screen 110 or uses the optical stylus pen 302 on the optical touch screen 310 after the display system 100 or the display system 300 has activated the command input mode, the predetermined commands may perform the following corresponding operations.

As illustrated in FIG. 4, the corresponding operation is enlarging an image displayed on the touch screen 110 or the optical touch screen 310 when the input command is a path 402 spiraling from inside to outside.

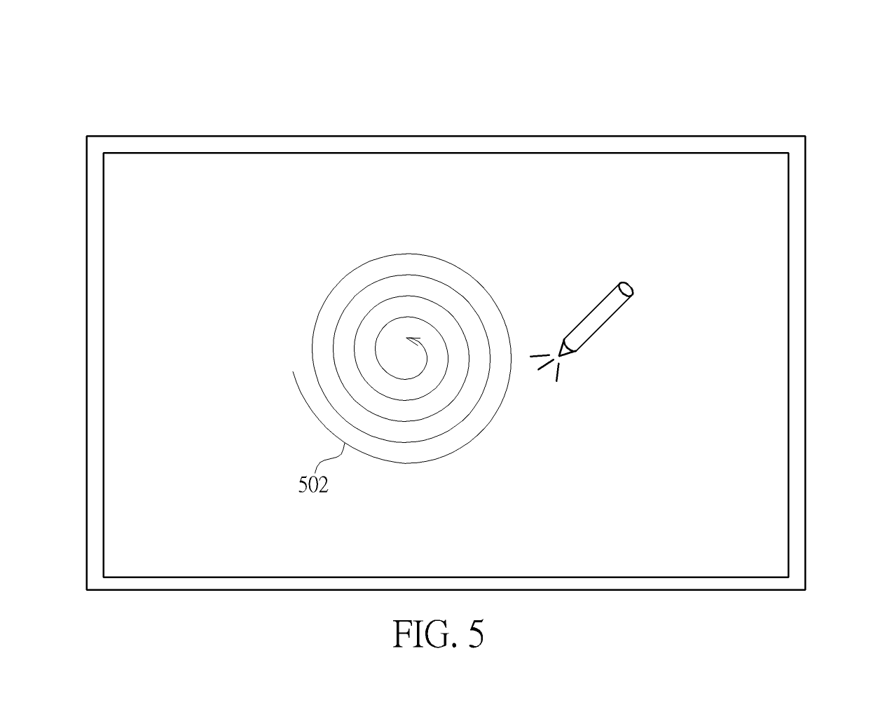

As illustrated in FIG. 5, the corresponding operation is shrinking an image display on the touch screen 110 or the optical touch screen 310 when the input command is a path 502 spiraling from outside to inside.

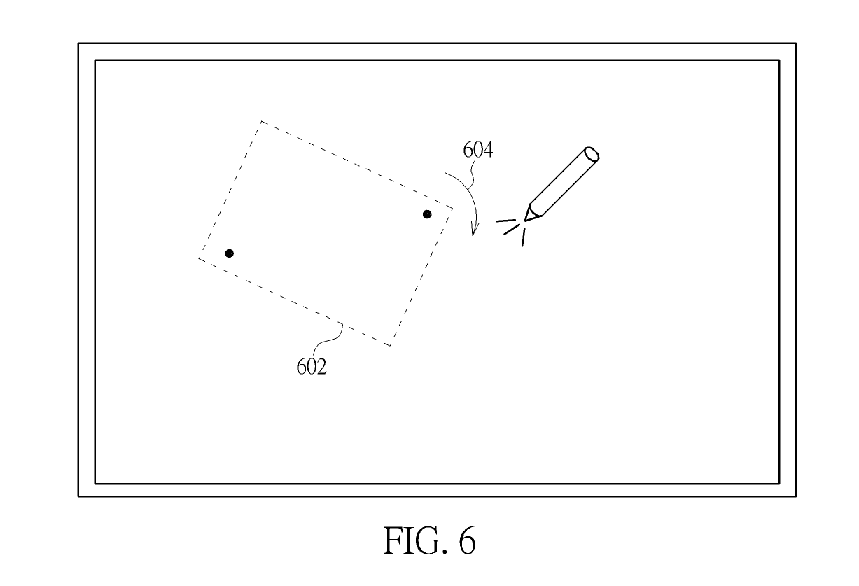

As illustrated in FIG. 6, the corresponding operation is turning an image in a block 602 when the input command is selecting the block 602, tapping two points on the diagonal of the block 602, and entering a curved path 604 on the touch screen 110 or the optical touch screen 310.

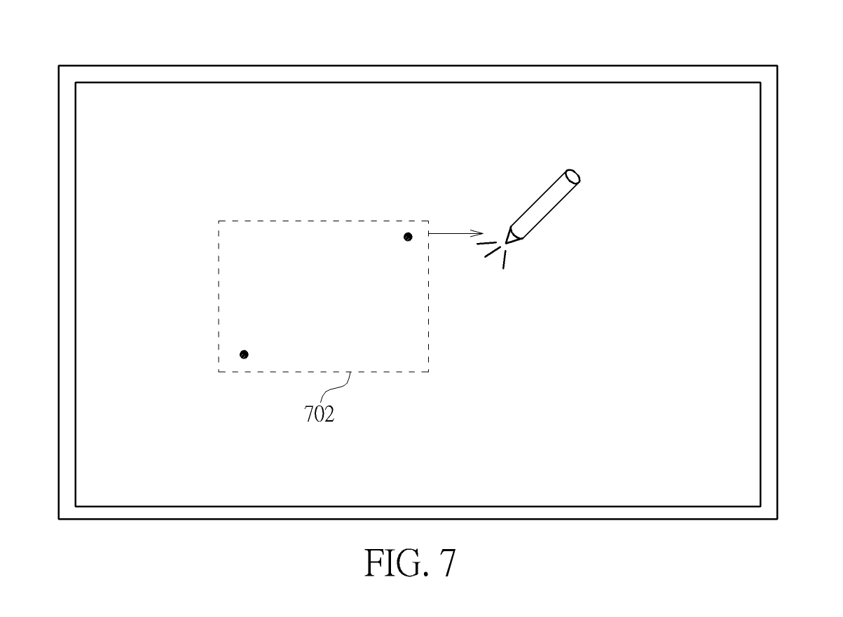

As illustrated in FIG. 7, the corresponding operation is dragging an image in a block 702 when the input command is tapping two points on the diagonal of the block 702 and dragging the block 702 on the touch screen 110 or the optical touch screen 310.

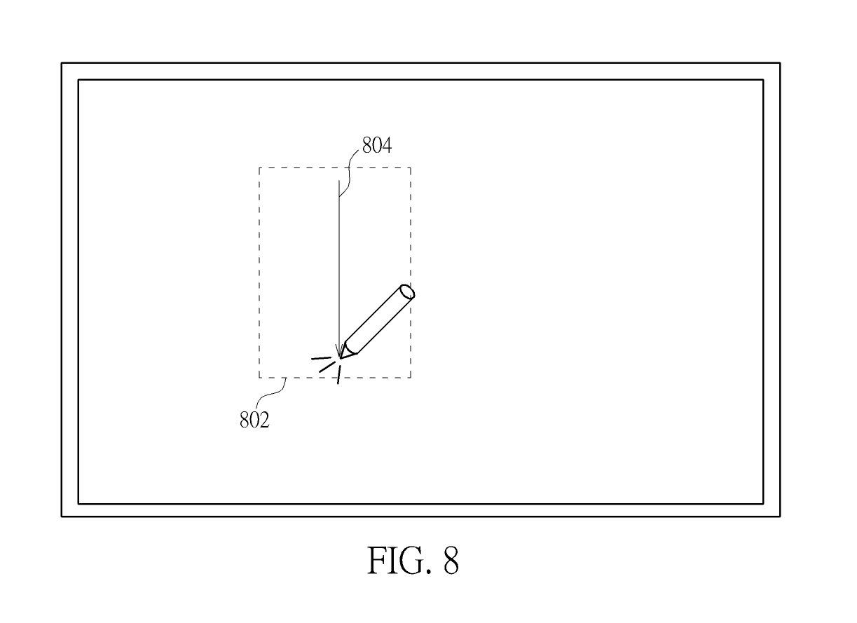

As illustrated in FIG. 8, the corresponding operation is to renew a page 802 displayed on the touch screen 110 or the optical touch screen 310 when the input command is a path 804 stretching along a first direction.

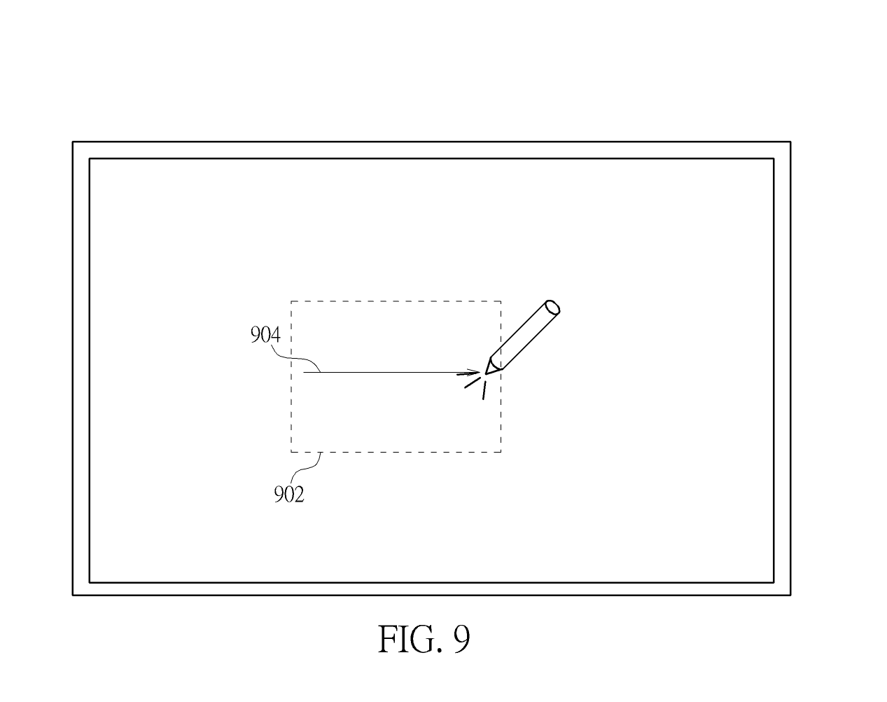

As illustrated in FIG. 9, the corresponding operation is going to a previous page of a page 902 on the touch screen 110 or the optical touch screen 310 when the input command is a path 904 stretching along a second direction.

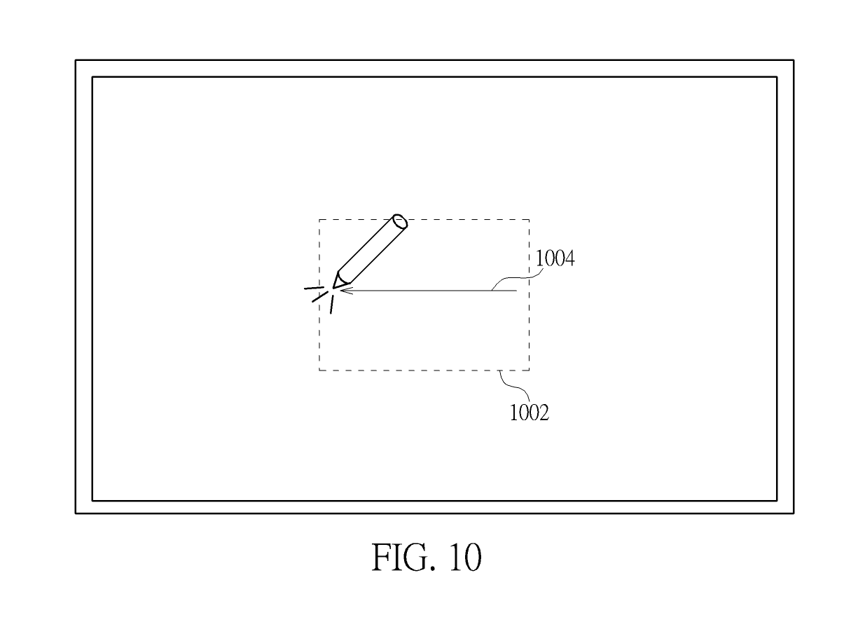

As illustrated in FIG. 10, the corresponding operation is going to a next page of a page 1002 on the touch screen 110 or the optical touch screen 310 when the input command is a path 1004 stretching along a third direction.

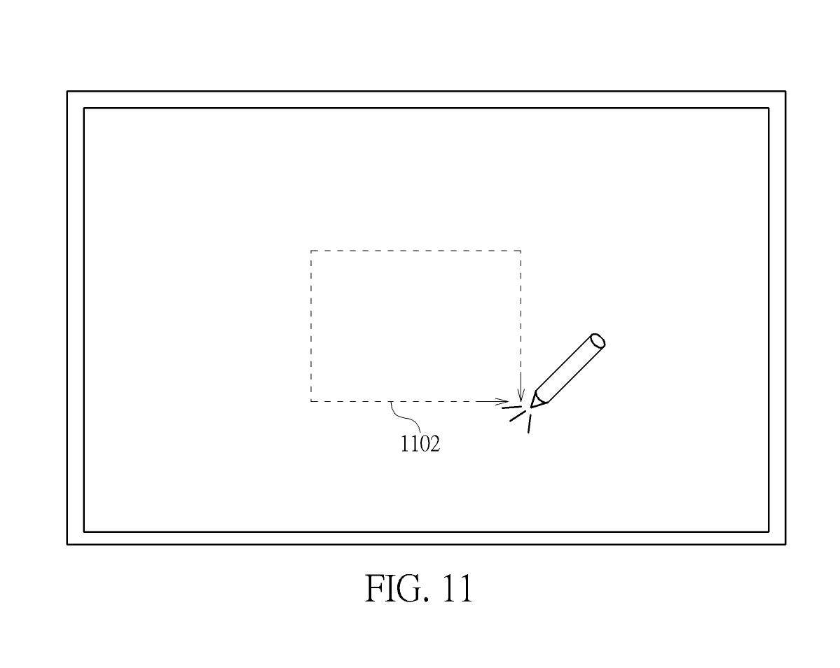

As illustrated in FIG. 11, the corresponding operation is selecting a block 1102 on the touch screen 110 or the optical touch screen 310 when the input command is enclosing the block 1102.

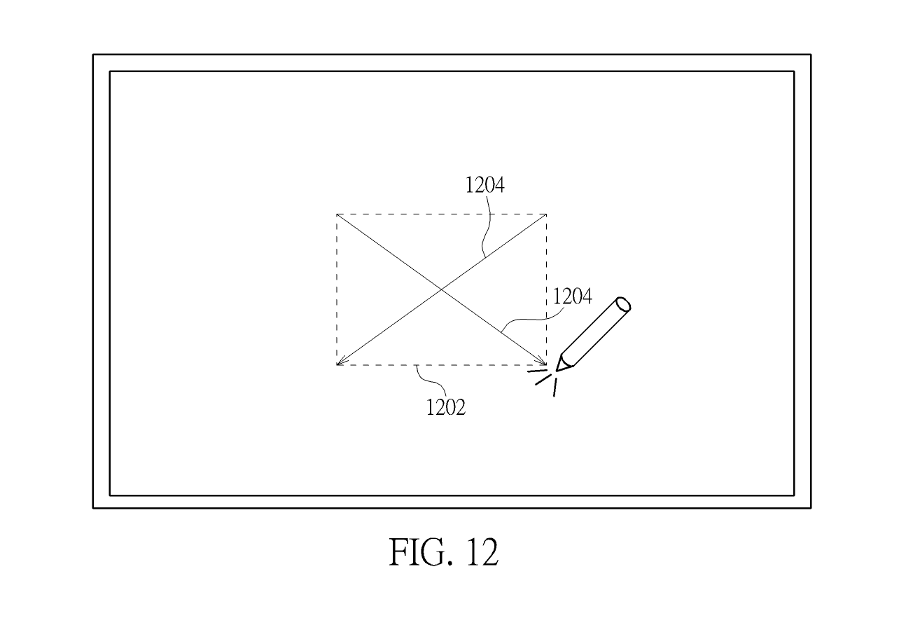

As illustrated in FIG. 12, the corresponding operation is deleting a selected block 1202 on the touch screen 110 or the optical touch screen 310 when the input command is drawing two diagonal lines of the selected block 1202.

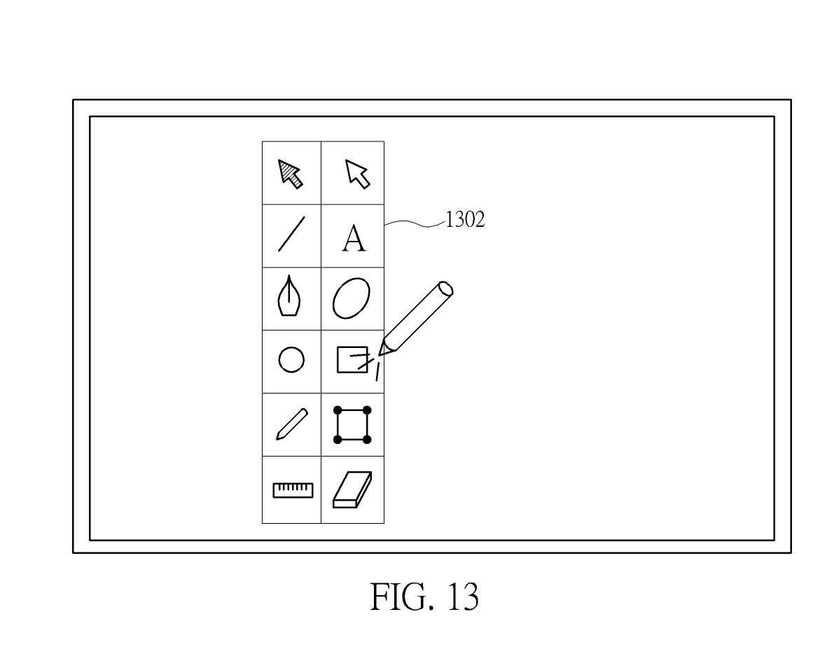

As illustrated in FIG. 13, the corresponding operation is opening a tool bar 1302 on the touch screen 110 or the optical touch screen 310 when the input command is staying on a location for a predetermined duration, for example 1 second.

The first direction of FIG. 8 is substantially perpendicular to the second direction of FIG. 9 and an angle between the third direction of FIG. 10 and the second direction of FIG. 9 is about 180 degrees.

In summary, embodiments of the disclosure let the user to operate touch screens in a new way instead of operating large size touch screen such as the electronic whiteboards in a traditional way by accessing the operational interfaces adjacent to frame borders of the electronic whiteboards. The user can activate the command input mode to control the touch screen at his/her original position. In other words, the user can operate the touch screen, which may be the electronic whiteboards, without bothering to move back and forth in front of the touch screen for selecting operation commands, thereby reducing time consumption and is more convenient for the user when operating the touch screen.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A display system control method, the display system comprising a stylus pen and a touch screen module, the touch screen module comprising a touch screen, the method comprising:
activating a command input mode of the display system by the stylus pen;
receiving an input command from the stylus pen to the touch screen by the touch screen after the command input mode of the display system is activated; and
according to which command among a plurality of predetermined commands of the display system to which the input command corresponds, performing a corresponding operation corresponding to the input command on the touch screen.

2. The method of claim 1, wherein activating the command input mode of the display system by the stylus pen is controlling the stylus pen by a switch thereof to transmit a wireless control signal to the touch screen module so that the display system activates the command input mode after the touch screen module has received the wireless control signal.

3. The method of claim 2, wherein:
the corresponding operation is enlarging an image displayed on the touch screen when the input command is a path spiraling from inside to outside;
the corresponding operation is shrinking an image display on the touch screen when the input command is a path spiraling from outside to inside;
the corresponding operation is turning an image in a block when the input command is selecting the block, tapping two points on the diagonal of the block, and entering a curved path;
the corresponding operation is dragging an image in a first block when the input command is tapping two points on the diagonal of the first block and dragging the first block;
the corresponding operation is renewing a page displayed on the touch screen when the input command is a path stretching along a first direction;
the corresponding operation is going to a previous page when the input command is a path stretching along a second direction, wherein the first direction is substantially perpendicular to the second direction;
the corresponding operation is going to a next page of the page when the input command is a path stretching along a third direction, wherein an angle between the third direction and the second direction is about 180 degrees;
the corresponding operation is selecting a second block when the input command is enclosing the second block;
the corresponding operation is deleting the selected block when the input command is drawing two diagonal lines of the second block; and
the corresponding operation is opening a tool bar when the input command is staying on a location for a predetermined duration.

4. The method of claim 1, wherein the stylus pen is an optical stylus pen, the touch screen is an optical touch screen, and activating the command input mode of the display system by the stylus pen is controlling brightness and/or color of light emitted from the optical stylus pen by a switch thereof so that the display system activates the command input mode according to the brightness and/or color of light emitted from the optical stylus pen to the optical touch screen.

5. The method of claim 4, wherein:
the corresponding operation is enlarging an image displayed on the touch screen when the input command is a path spiraling from inside to outside;
the corresponding operation is shrinking an image display on the touch screen when the input command is a path spiraling from outside to inside;
the corresponding operation is turning an image in a block when the input command is selecting the block, tapping two points on the diagonal of the block, and entering a curved path;
the corresponding operation is dragging an image in a first block when the input command is tapping two points on the diagonal of the first block and dragging the first block;
the corresponding operation is renewing a page displayed on the touch screen when the input command is a path stretching along a first direction;
the corresponding operation is going to a previous page of the page when the input command is a path stretching along a second direction, wherein the first direction is substantially perpendicular to the second direction;
the corresponding operation is going to a next page of the page when the input command is a path stretching along a third direction, wherein an angle between the third direction and the second direction is about 180 degrees;
the corresponding operation is selecting a second block when the input command is enclosing the second block;
the corresponding operation is deleting the selected block when the input command is drawing two diagonal lines of the second block; and
the corresponding operation is opening a tool bar when the input command is staying on a location for a predetermined duration.

6. The method of claim 1, wherein:
the corresponding operation is enlarging an image displayed on the touch screen when the input command is a path spiraling from inside to outside;
the corresponding operation is shrinking an image display on the touch screen when the input command is a path spiraling from outside to inside;
the corresponding operation is turning an image in a block when the input command is selecting the block, tapping two points on the diagonal of the block, and entering a curved path;
the corresponding operation is dragging an image in a first block when the input command is tapping two points on the diagonal of the first block and dragging the first block;
the corresponding operation is renewing a page displayed on the touch screen when the input command is a path stretching along a first direction;
the corresponding operation is going to a previous page of the page when the input command is a path stretching along a second direction, wherein the first direction is substantially perpendicular to the second direction;
the corresponding operation is going to a next page of the page when the input command is a path stretching along a third direction, wherein an angle between the third direction and the second direction is about 180 degrees;
the corresponding operation is selecting a second block when the input command is enclosing the second block;
the corresponding operation is deleting the selected block when the input command is drawing two diagonal lines of the second block; and
the corresponding operation is opening a tool bar when the input command is staying on a location for a predetermined duration.

7. A display system control method, the display system comprising a stylus pen and a touch screen module, the touch screen module comprising a touch screen, the method comprising:
receiving an input command from the stylus pen to the touch screen by the touch screen;
according to whether the display system has activated a command input mode of the display system by the stylus pen deciding whether or not to determine which command among a plurality of predetermined commands of the display system the input command corresponds to; and
after the command input mode of the display system has been activated by the stylus pen, determining which command among the plurality of predetermined commands of the display system to which the input command corresponds and performing a corresponding operation corresponding to the input command on the touch screen after the command among the plurality of predetermined commands of the display system that the input command corresponds to has been determined.

8. The method of claim 7, wherein activating the command input mode of the display system by the stylus pen is controlling the stylus pen by a switch thereof to transmit a wireless control signal to the touch screen module so that the display system activates the command input mode after the touch screen module has received the wireless control signal.

9. The method of claim 8, wherein:
the corresponding operation is enlarging an image displayed on the touch screen when the input command is a path spiraling from inside to outside;
the corresponding operation is shrinking an image display on the touch screen when the input command is a path spiraling from outside to inside;
the corresponding operation is turning an image in a block when the input command is selecting the block, tapping two points on the diagonal of the block, and entering a curved path;
the corresponding operation is dragging an image in a first block when the input command is tapping two points on the diagonal of the first block and dragging the first block;
the corresponding operation is renewing a page displayed on the touch screen when the input command is a path stretching along a first direction;
the corresponding operation is going to a previous page of the page when the input command is a path stretching along a second direction, wherein the first direction is substantially perpendicular to the second direction;
the corresponding operation is going to a next page of the page when the input command is a path stretching along a third direction, wherein an angle between the third direction and the second direction is about 180 degrees;
the corresponding operation is selecting a second block when the input command is enclosing the second block;
the corresponding operation is deleting the selected block when the input command is drawing two diagonal lines of the second block; or
the corresponding operation is opening a tool bar when the input command is staying on a location for a predetermined duration.

10. The method of claim 7 wherein the stylus pen is an optical stylus pen, the touch screen is an optical touch screen, and activating the command input mode of the display system by the stylus pen is controlling brightness and/or color of light emitted from the optical stylus pen by a switch thereof so that the display system activates the command input mode according to the brightness and/or color of light emitted from the optical stylus pen to the optical touch screen.

11. The method of claim 10, wherein:
the corresponding operation is enlarging an image displayed on the touch screen when the input command is a path spiraling from inside to outside;
the corresponding operation is shrinking an image display on the touch screen when the input command is a path spiraling from outside to inside;
the corresponding operation is turning an image in a block when the input command is selecting the block, tapping two points on the diagonal of the block, and entering a curved path;
the corresponding operation is dragging an image in a first block when the input command is tapping two points on the diagonal of the first block and dragging the first block;
the corresponding operation is renewing a page displayed on the touch screen when the input command is a path stretching along a first direction;
the corresponding operation is going to a previous page of the page when the input command is a path stretching along a second direction, wherein the first direction is substantially perpendicular to the second direction;
the corresponding operation is going to a next page of the page when the input command is a path stretching along a third direction, wherein an angle between the third direction and the second direction is about 180 degrees;
the corresponding operation is selecting a second block when the input command is enclosing the second block;
the corresponding operation is deleting the selected block when the input command is drawing two diagonal lines of the second block; or
the corresponding operation is opening a tool bar when the input command is staying on a location for a predetermined duration.

12. The method of claim 7, wherein:
the corresponding operation is enlarging an image displayed on the touch screen when the input command is a path spiraling from inside to outside;
the corresponding operation is shrinking an image display on the touch screen when the input command is a path spiraling from outside to inside;
the corresponding operation is turning an image in a block when the input command is selecting the block, tapping two points on the diagonal of the block, and entering a curved path;
the corresponding operation is dragging an image in a first block when the input command is tapping two points on the diagonal of the first block and dragging the first block;
the corresponding operation is renewing a page displayed on the touch screen when the input command is a path stretching along a first direction;
the corresponding operation is going to a previous page of the page when the input command is a path stretching along a second direction, wherein the first direction is substantially perpendicular to the second direction;
the corresponding operation is going to a next page of the page when the input command is a path stretching along a third direction, wherein an angle between the third direction and the second direction is about 180 degrees;
the corresponding operation is selecting a second block when the input command is enclosing the second block;
the corresponding operation is deleting the selected block when the input command is drawing two diagonal lines of the second block; or
the corresponding operation is opening a tool bar when the input command is staying on a location for a predetermined duration.

13. A display system comprising:
a stylus pen configured to activate a command input mode of the display system; and
a touch screen module configured to receive inputs of the stylus pen, the touch screen module comprising:
a touch screen configured to receive an input command from the stylus pen to the touch screen; and
a controller coupled to the touch screen and configured to according to which command among a plurality of predetermined commands of the display system the input command corresponds to, control the touch screen to perform a corresponding operation corresponding to the input command after the command input mode has been activated.

14. The display system of claim 13, wherein the stylus pen comprises:
a switch configured to generate a wireless control signal; and
a transmitter configured to transmit the wireless control signal to the touch screen module.

15. The display system of claim 14, wherein the controller comprises:
a receiver configured to receive the wireless control signal transmitted from the transmitter;
wherein the display system is configured to activate the command input mode after the receiver has received the wireless control signal.

16. The display system of claim 15, wherein:
the corresponding operation is enlarging an image displayed on the touch screen when the input command is a path spiraling from inside to outside;
the corresponding operation is shrinking an image display on the touch screen when the input command is a path spiraling from outside to inside;
the corresponding operation is turning an image in a block when the input command is selecting the block, tapping two points on the diagonal of the block, and entering a curved path;
the corresponding operation is dragging an image in a first block when the input command is tapping two points on the diagonal of the first block and dragging the first block;
the corresponding operation is renewing a page displayed on the touch screen when the input command is a path stretching along a first direction;
the corresponding operation is going to a previous page of the page when the input command is a path stretching along a second direction, wherein the first direction is substantially perpendicular to the second direction;
the corresponding operation is going to a next page of the page when the input command is a path stretching along a third direction, wherein an angle between the third direction and the second direction is about 180 degrees;
the corresponding operation is selecting a second block when the input command is enclosing the second block;
the corresponding operation is deleting the selected block when the input command is drawing two diagonal lines of the second block; or
the corresponding operation is opening a tool bar when the input command is staying on a location for a predetermined duration.

17. The display system of claim 13, wherein:
the stylus pen is an optical stylus pen comprising a switch configured to control brightness and/or color of light emitted from the optical stylus pen; and
the touch screen is an optical touch screen and the display system is configured to activate the command input mode according to the brightness and/or color of light emitted from the optical stylus pen to the optical touch screen.

18. The display system of claim 17, wherein:
the corresponding operation is enlarging an image displayed on the touch screen when the input command is a path spiraling from inside to outside;
the corresponding operation is shrinking an image display on the touch screen when the input command is a path spiraling from outside to inside;
the corresponding operation is turning an image in a block when the input command is selecting the block, tapping two points on the diagonal of the block, and entering a curved path;
the corresponding operation is dragging an image in a first block when the input command is tapping two points on the diagonal of the first block and dragging the first block;
the corresponding operation is renewing a page displayed on the touch screen when the input command is a path stretching along a first direction;
the corresponding operation is going to a previous page of the page when the input command is a path stretching along a second direction, wherein the first direction is substantially perpendicular to the second direction;
the corresponding operation is going to a next page of the page when the input command is a path stretching along a third direction, wherein an angle between the third direction and the second direction is about 180 degrees;
the corresponding operation is selecting a second block when the input command is enclosing the second block;
the corresponding operation is deleting the selected block when the input command is drawing two diagonal lines of the second block; or
the corresponding operation is opening a tool bar when the input command is staying on a location for a predetermined duration.

19. The display system of claim 13, wherein:
the corresponding operation is enlarging an image displayed on the touch screen when the input command is a path spiraling from inside to outside;
the corresponding operation is shrinking an image display on the touch screen when the input command is a path spiraling from outside to inside;
the corresponding operation is turning an image in a block when the input command is selecting the block, tapping two points on the diagonal of the block, and entering a curved path;
the corresponding operation is dragging an image in a first block when the input command is tapping two points on the diagonal of the first block and dragging the first block;
the corresponding operation is renewing a page displayed on the touch screen when the input command is a path stretching along a first direction;
the corresponding operation is going to a previous page of the page when the input command is a path stretching along a second direction, wherein the first direction is substantially perpendicular to the second direction;
the corresponding operation is going to a next page of the page when the input command is a path stretching along a third direction, wherein an angle between the third direction and the second direction is about 180 degrees;
the corresponding operation is selecting a second block when the input command is enclosing the second block;
the corresponding operation is deleting the selected block when the input command is drawing two diagonal lines of the second block; or
the corresponding operation is opening a tool bar when the input command is staying on a location for a predetermined duration.

20. The display system of claim 13, wherein the controller is further configured to according to whether the command input mode has been activated by the stylus pen to decide whether or not to determine which command among a plurality of predetermined commands of the display system the input command corresponds to.
